(19) United States
(12) Patent Application Publication
(10) Pub. No.: US 2019/0200273 A1
(43) Pub. Date: Jun. 27, 2019

(54) Flushing PDCP Packets To Reduce Network Load In Multi-Connectivity Scenarios

(71) Applicant: Nokia Technologies Oy, Espoo (FI)

(72) Inventors: Klaus I. Pedersen, Aalborg (DK); Daniela Laselva, Klarup (DK); Nurul Mahmood, Aalborg (DK)

(21) Appl. No.: 15/851,935

(22) Filed: Dec. 22, 2017

(51) Int. Cl. H04W 40/12; H04L 12/823; H04L 29/06

(52) U.S. Cl. CPC H04W 40/12; H04W 88/02; H04L 69/22; H04L 47/32

(57) ABSTRACT

An anchor node receives a packet, duplicates the packet to form two copies, flags each of two data units, each comprising one of the copies, with a duplication flag indicating the corresponding data unit comprises a copy. The anchor node sends one of the two data units through protocol layers towards transmission to a UE, and sends another of the two data units over a network interface and towards one or more duplicating nodes. A duplicating node receives in the data unit a copy of the packet. The duplicating node forwards the data unit with the packet to a first of multiple protocol layers toward transmission via an air interface toward the UE. The duplicating node discards, in the first protocol layer or in a layer lower than the first, the packet in response to receiving an ACK that a copy of the packet was successfully received by the UE.

### TECHNICAL FIELD

This invention relates generally to multi-connectivity (such as dual connectivity) in wireless communication networks and, more specifically, relates to packet data convergence protocol packet routing in these networks.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is hot admitted to be prior art by inclusion in this section. Abbreviations that may be found in the specification and/or the drawing figures are defined below, after the main part of the detailed description section.

Dual connectivity (DC), as standardized by 3GPP in LTE Releases 12/13, extends the LTE-Advanced carrier aggregation (CA) functionality to allow a user equipment (UE) to simultaneously receive/send data from two different eNBs. So far DC has been proposed as a solution to boost throughput performance, using data split at a PDCP layer.

In 5G new radio (NR) standardization activities, DC and multi-connectivity (MC) are being proposed as potential solutions for Ultra Reliable Low Latency Communication (URLLC) applications with the objective of boosting data robustness and reliability by means of data duplication across the different nodes. As typically used, dual connectivity is for cases where the UE is connected to two base station nodes, while MC is a general term for a UE connected to N (N>1) base station nodes.

It would be beneficial to improve the operation of DC/MC downlink for URLLC and HRLC (High Reliability Low Latency) applications in 5G NR (e.g., NR DC) as well as in NR-LTE DC (i.e., EN-DC, NE-DC).

### BRIEF SUMMARY

This section is intended to include examples and is not intended to be limiting.

In an exemplary embodiment, a method is disclosed that comprises receiving a packet at an anchor node in a communications network and duplicating, by the anchor node, the packet to form two copies of the packet. The method also includes flagging, by the anchor node, each of two data units, each comprising one of the two copies, with a duplication flag indicating the corresponding data unit comprises a copy of the packet. The method further includes sending, by the anchor node, one of the two data units, with one of the copies, through a plurality of protocol layers toward transmission via an air interface toward a user equipment. The method includes sending, by the anchor node, another of the two data units, with the other copy, over a network interface and toward one or more duplicating nodes.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An exemplary apparatus includes one or more processors and one or more memories including computer program code. The one or more memories and the computer program code are configured to, with the one or more processors, cause the apparatus to perform at least the following: receiving a packet at an anchor node in a communications network; duplicating, by the anchor node, the packet to form two copies of the packet; flagging, by the anchor node, each of two data units, each comprising one of the two copies, with a duplication flag indicating the corresponding data unit comprises a copy of the packet; sending, by the anchor node, one of the two data units, with one of the copies, through a plurality of protocol layers toward transmission via an air interface toward a user equipment; and sending, by the anchor node, another of the two data units, with the other copy, over a network interface and toward one or more duplicating nodes.

An exemplary computer program product includes a computer-readable storage medium bearing computer program code embodied therein for use with a computer. The computer program code includes: code for receiving a packet at an anchor node in a communications network; code for duplicating, by the anchor node, the packet to form two copies of the packet; code for flagging, by the anchor node, each of two data units, each comprising one of the two copies, with a duplication flag indicating the corresponding data unit comprises a copy of the packet; code for sending, by the anchor node, one of the two data units, with one of the copies, through a plurality of protocol layers toward transmission via an air interface toward a user equipment; and code for sending, by the anchor node, another of the two data units, with the other copy, over a network interface and toward one or more duplicating nodes.

In another exemplary embodiment, an apparatus comprises: means for receiving a packet at an anchor node in a communications network; means for duplicating, by the anchor node, the packet to form two copies of the packet; means for flagging, by the anchor node, each of two data units, each comprising one of the two copies, with a duplication flag indicating the corresponding data unit comprises a copy of the packet; means for sending, by the anchor node, one of the two data units, with one of the copies, through a plurality of protocol layers toward transmission via an air interface toward a user equipment; and means for sending, by the anchor node, another of the two data units, with the other copy, over a network interface and toward one or more duplicating nodes.

In an exemplary embodiment, a method is disclosed that includes receiving a data unit at a duplicating node in a communications network, wherein the duplicating node receives in the data unit a copy of a packet that is also sent via one or more nodes in a duplication set of nodes toward a user equipment, the data unit comprising a duplication flag indicating the corresponding data unit comprises a copy of the packet. The method includes forwarding the data unit with the packet to a first protocol layer of a plurality of layers toward transmission via an air interface toward the user equipment. The method also includes discarding, in the first protocol layer or in a layer lower than the first protocol layer, the packet in response to receiving an acknowledgement at the duplicating node that a copy of the packet was successfully received by the user equipment.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An exemplary apparatus includes one or more processors and one or more memories including computer program code. The one or more memories and the computer program code are configured to, with the one or more processors, cause the apparatus to perform at least the following: receiving a data unit at a duplicating node in a communications network, wherein the duplicating node receives in the data unit a copy of a packet that is also sent via one or more nodes in a duplication set of nodes toward a user equipment, the data unit comprising a duplication flag indicating the corresponding data unit comprises a copy of the packet; forwarding the data unit with the packet to a first protocol layer of a plurality of layers toward transmission via an air interface toward the user equipment; and discarding, in the first protocol layer or in a layer lower than the first protocol layer, the packet in response to receiving an acknowledgement at the duplicating node that a copy of the packet was successfully received by the user equipment.

An exemplary computer program product includes a computer-readable storage medium bearing computer program code embodied therein for use with a computer. The computer program code includes: code for receiving a data unit at a duplicating node in a communications network, wherein the duplicating node receives in the data unit a copy of a packet that is also sent via one or more nodes in a duplication set of nodes toward a user equipment, the data unit comprising a duplication flag indicating the corresponding data unit comprises a copy of the packet; code for forwarding the data unit with the packet to a first protocol layer of a plurality of layers toward transmission via an air interface toward the user equipment; and code for discarding, in the first protocol layer or in a layer lower than the first protocol layer, the packet in response to receiving an acknowledgement at the duplicating node that a copy of the packet was successfully received by the user equipment.

In another exemplary embodiment, an apparatus comprises: means for receiving a data unit at a duplicating node in a communications network, wherein the duplicating node receives in the data unit a copy of a packet that is also sent via one or more nodes in a duplication set of nodes toward a user equipment, the data unit comprising a duplication flag indicating the corresponding data unit comprises a copy of the packet; means for forwarding the data unit with the packet to a first protocol layer of a plurality of layers toward transmission via an air interface toward the user equipment; and means for discarding, in the first protocol layer or in a layer lower than the first protocol layer, the packet in response to receiving an acknowledgement at the duplicating node that a copy of the packet was successfully received by the user equipment.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 illustrates NR DC/MC operation with data duplication in the downlink direction;

FIG. 3 shows exemplary packet transfer through different protocol layers in an apparatus such as a gNB or UE;

FIG. 4 illustrates an example of a PDCP header, and this figure is a modified copy of FIG. 6.2.2.3-1, “PDCP Data PDU format for DRBs with 18 bits PDCP SN (applicable for UM DRBs and AM DRBs)”, from 3GPP TS 38.323 V1.0.1 (2017-October);

FIG. 5 illustrates NR DC/MC operation with data duplication in the downlink direction, in accordance with an exemplary embodiment;

FIG. 6 is a message flow diagram of a process for flushing PDCP packets to reduce network load in multi-connectivity scenarios, and is performed by a duplicating node; and

FIG. 7 is a logic flow diagram of part of a process for flushing PDCP packets to reduce network load in multi-connectivity scenarios, and is performed by an anchor node.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for flushing PDCP packets to reduce network load in multi-connectivity scenarios. Additional description of these techniques is presented after a system into which the exemplary embodiments may be used is described.

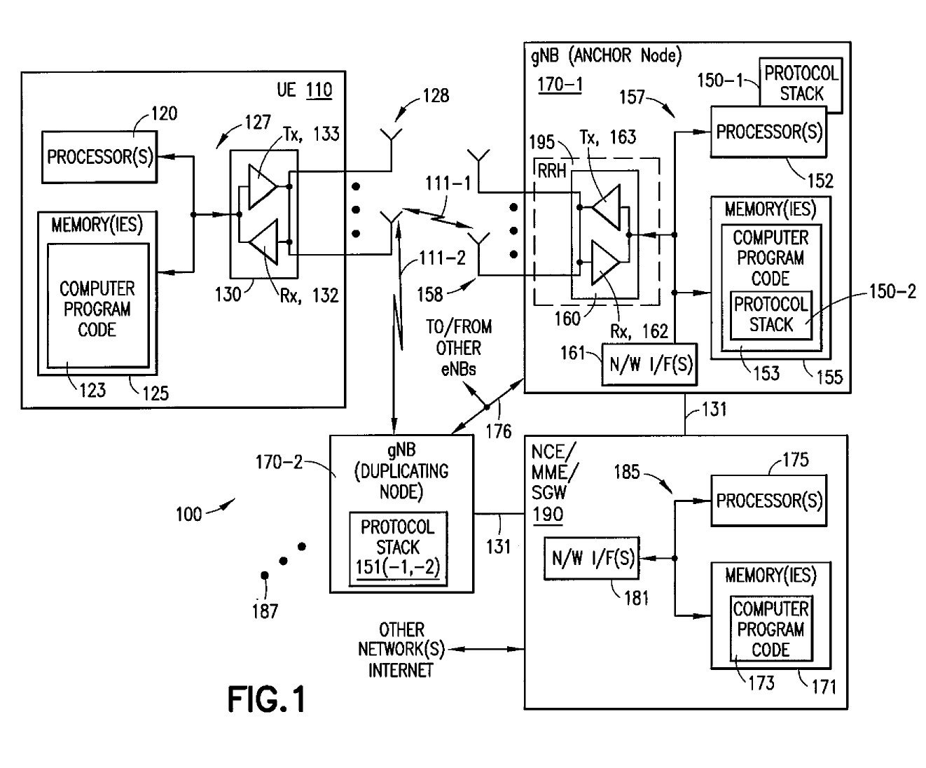

Turning to FIG. 1, this figure shows a block diagram of one possible and non-limiting exemplary system in which the exemplary embodiments may be practiced. In FIG. 1, a user equipment (UE) 110 is in wireless communication with a wireless communications network 100. A UE is a wireless, typically mobile device that can access a wireless communications network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. For instance, the one or more memories 125 and the computer program code 123 may be configured to, with the one or more processors 120, cause the user equipment 110 to perform one or more of the operations as described herein.

The UE 110 communicates with gNB 170-1 via a wireless link 111-1 and communicates with gNB 170-2 with wireless link 111-2. In this example, there are two gNBs 170, although there could be three or more (as indicated by ellipses 187). The gNB 170-1 is referred to as an anchor node, and the gNB 170-2 is referred to a duplicating node, and these terms are described in more detail below. One exemplary possible internal configuration for the gNB 170-1 is described below, and it is assumed that the internal configuration for the gNB 170-2 is similar, and therefore only potential differences are described below.

Each gNB (evolved NodeB) 170 is a base station (e.g., for NR) that provides access by wireless devices such as the UE 110 to the wireless communications network 100. The gNB 170-1 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The gNB 170-1 includes a protocol stack 150, comprising one of or both parts 150-1 and/or 150-2, which may be implemented in a number of ways. The protocol stack 150 may be implemented in hardware as protocol stack 150-1, such as being implemented as part of the one or more processors 152. The protocol stack 150-1 may be implemented also as an integrated circuit or through other hardware such as a programmable gate array. In another example, the protocol stack 150 may be implemented as protocol stack 150-2, which is implemented as computer program code 153 and is executed by the one or more processors 152. For instance, the one or more memories 155 and the compute program code 153 are configured to, with the one or more processors 152, cause the gNB 170-1 to perform one or more of the operations as described herein. The one or more network interfaces 161 communicate over a network such as via the links 176 and 131. Two or more gNBs 170 communicate using, e.g., link 176. The link 176 may be wired or wireless or both and may implement, e.g., an Xn interface for a gNB.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the gNB 170-1 being physically in a different location from the RRH, and the one or more buses 157 could be implemented in part as fiber optic cable to connect the other elements of the gNB 170-1 to the RRH 195.

The gNB 170-2 includes a protocol stack 151 that may be implemented in hardware as protocol stack 151-1, such as being implemented as part of the one or more processors 152. The protocol stack 151-1 may be implemented also as an integrated circuit or through other hardware such as a programmable gate array. In another example, the protocol stack 151 may be implemented as protocol stack 151-2, which is implemented as computer program code 153 and is executed by the one or more processors 152. For instance, the one or more memories 155 and the computer program code 153 are configured to, with the one or more processors 152, cause the gNB 170-2 to perform one or more of the operations as described herein.

The wireless network 100 may include a network control element (NCE) 190 that may include MME (Mobility Management Entity)/SGW (Serving Gateway) functionality, and which provides connectivity with a further network, such as a telephone network and/or a data communications network (e.g., the Internet). The gNB 170 is coupled via a link 131 to the NCE 190. The link 131 may be implemented as, e.g., an SI interface. The NCE 190 includes one or more processors 175, one or more memories 171, and one or more network interfaces (N/W I/F(s)) 181, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, gNB 170, and other functions as described herein.

Having thus introduced one suitable but non-limiting technical context for the practice of the exemplary embodiments of this invention, the exemplary embodiments will now be described with greater specificity. Below, we propose new solutions to improve usage of DC/MC PDCP data duplication by introducing mechanisms to further prevent and/or minimize transmissions of PDCP packets that have already been correctly transferred at the UE. It is helpful to review additional background material before addressing the exemplary embodiments.

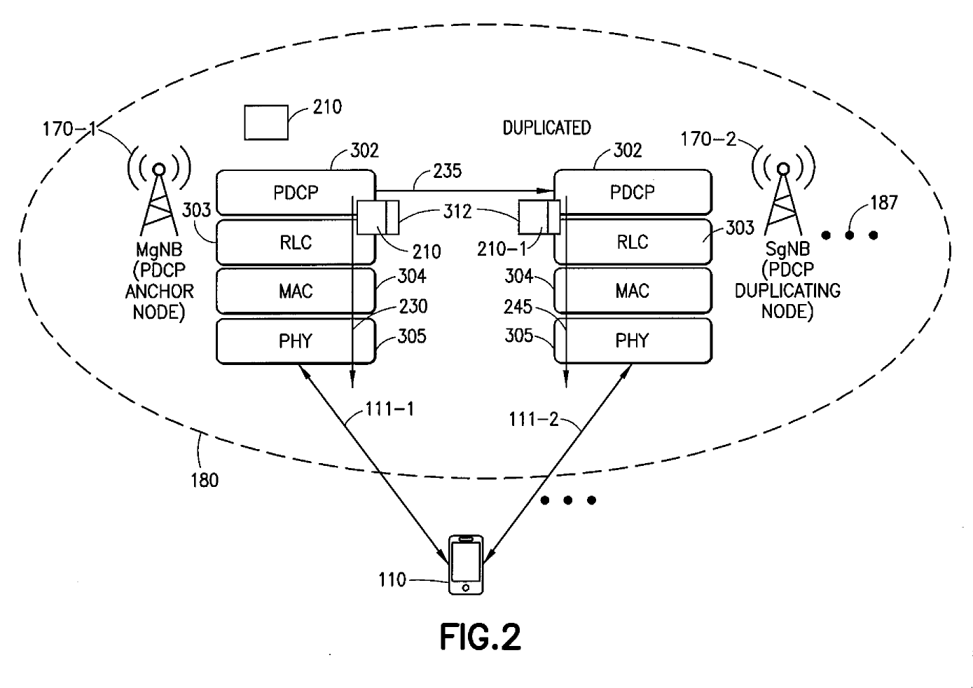

NR DC/MC operation with data duplication in the downlink (DL) direction is schematically presented in FIG. 2. The gNB 170-1, which is in control of the PDCP duplication, is called the PDCP anchor node (or the MgNB), whereas any other gNB 170-2 serving the duplicated PDCP packet for a given UE is termed as the PDCP duplicating node (or the SgNB). The following layers are shown in each of the gNBs: PDCP layer 302, RLC layer 303, MAC layer 304, and PHY layer 305. When a packet 210 arrives at the PDCP-anchor gNB, the packet 210 may be duplicated at the PDCP layer 302 and, if so, the duplicated packet 210-1 is forwarded to the PDCP duplicating gNB node(s) 170-2 (of which only one is shown in FIG. 2) over the Xn interface via link 235. The same data packet (i.e., PDCP PDU 312, with a given sequence number, SN) is then independently transmitted to the same UE 110 through the multiple links 111-1 and 111-2 (via both the anchor gNB 170-1 and the duplicating gNBs 170-2). That is, one PDCP PDU 312 travels via path 230 through the layers of the anchor node gNB 170-1 and then through the air interface and link 111-1 to the UE 110, and the packet 210 travels via PDCP PDU 312 through the link 235 then through path 245 (and layers 302-305) of the duplicating node 170-2 and the air interface and link 111-2 to the UE 110. The set 180 of gNBs 170 (i.e., 170-1 and one or more of 170-2) transmitting the duplicated packet is termed in this document as the duplication set.

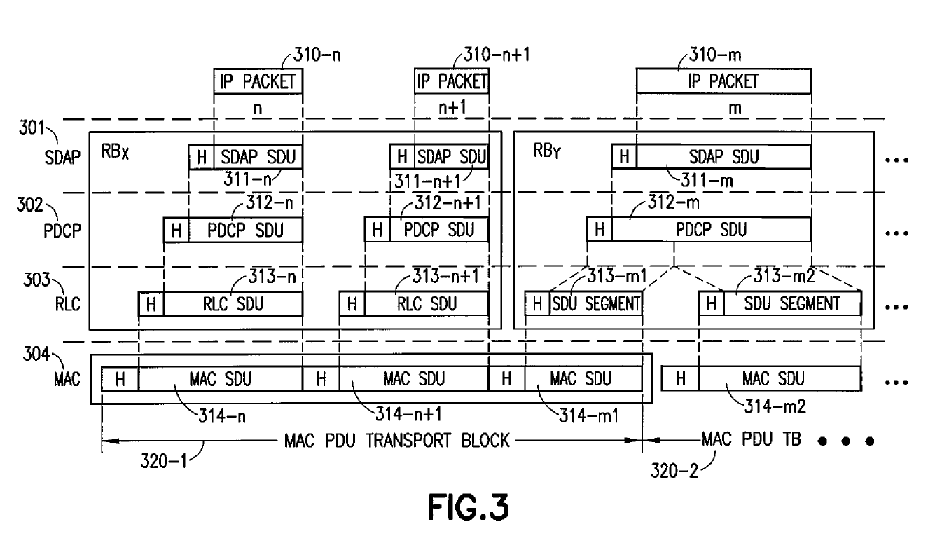

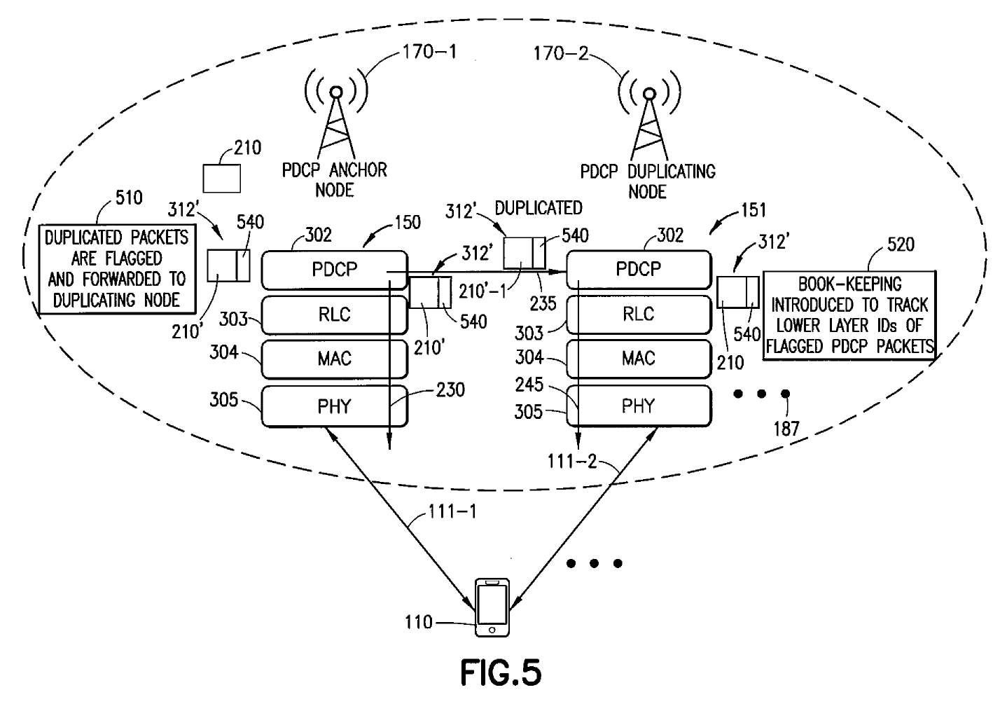

FIG. 3 shows the packet transfer through the different protocol layers for apparatus such as a gNB. Multiple layers are illustrated: SDAP layer 301, PDCP layer 302, RLC layer 303, and MAC layer 304. These are listed in order from an upper layer (SDAP layer 301) to a lower layer PCDP layer 302, to an even lower layer (RLC layer 303), to an even lower layer (MAC layer 304). The lowest layer is the PHY layer 305, shown in FIGS. 2 and 5), and the highest layer shown is the SDAP layer 301. Note that “lower” and “upper” layers are defined as such for this well-known protocol stack. For the DL direction, an IP packet 310-n is formed into an SDAP SDU 311-n with header (H) in the SDAP layer 301, which itself is formed into a PDCP SDU 312-n plus header (H) in the PDCP layer 302, which is then formed into an RLC SDU 313-n plus header (H) in the RLC layer 303, which then is packaged into the MAC PDU transport block (TB) 320-1 via the MAC SDU 314-n and its header (H). The IP packet 310-n+1 is similarly formed into an SDAP SDU 311-n+1 with header (H) in the SDAP layer 301, which itself is formed into a PDCP SDU 312-n+1 plus header (H) in the PDCP layer 302, which is then formed into an RLC SDU 313-n+1 plus header (H) in the RLC layer 303, which then is packaged into the MAC PDU transport block (TB) 320-1 via the MAC SDU 314-n+1 and its header (H). The IP packet 310-m is similarly handled into the SDAP SDU 311-m and the PDCP SDU 312-m. In order to create a “full” MAC PDU transport block 320-1, the “front” part of the header H and PDCP SDU 312-m is put into an SDU segment 313-m1 and header (H) in the RLC layer 303 and then used to fill the rest of the MAC PDU transport block 320-1 via the MAC SDU 314-m1 and its header (H). The “back” part of the PDCP SDU 312-m is put into an SDU segment 313-m2 and header (H) in the RLC layer 303 and then used to fill the beginning of the (next) MAC PDU transport block 320-2 via the MAC SDU 314-m2 and its header (H).

It should be noted that the SDUs are packaged into PDUs, which include the headers (Hs). For instance, the combination of the header (H) and the SDAP SDU make an SDAP PDU. This is the same for the other layers 302, 303, and 304.

For cases with occasional URLLC transmissions, it is typically assumed that the messages (payload) are small, and with an average arrival with latencies of tens of milliseconds between consecutive packets. It is therefore fair to assume that a single URLLC payload (say in an IP packet 310) is transferred on a one-to-one basis: one SDAP SDU-one PDCP SDU-one RLC SDU-one MAC SDU-transport block MAC PDU. Among others, this is a consequence of URLLC data being prioritized also by the MAC level scheduler to schedule such high priority latency critical data as fast as possible because of the stringent requirements. Hence, it is a valid assumption to assume that the URLLC payload (e.g., IP packet 310) will be sent over the air interface in a single MAC PDU transport block, carrying only that information from a single resource block (RB).

A HARQ mechanism is part of the MAC layer 304, operated independently for each link (e.g., node). HARQ positive acknowledgment (ACK) signaling for each physical layer (PHY) transmission is sent to the transmitting gNB. That is, the transmission from the anchor gNB 170-1 is acknowledged by the UE 110 to the anchor gNB 170-1, and that ACK will provide the indication that the PDCP PDUs mapped to the transmission were successfully received. This is under the assumption that for URLLC use cases, RLC unacknowledged mode (UM) and therefore no RLC ACKs (e.g., RLC status reports) are available as indication of successful delivery to the upper layer (i.e., PDCP). Similarly, the MAC-layer transmission from the duplicating gNB 170-2 is acknowledged from the UE 110 to that particular gNB 170-2. It should be noted that the duplicating gNB will provide the indication of successful delivery to the anchor gNB 170-1 by means of flow control (i.e., PDCP-level data status delivery procedure over Xn).

When a PDCP packet (with a particular SN) is received successfully at the UE 110 from any leg, any later copy of that SN received at the UE 110 through other legs in the duplication set will be discarded at the PDCP layer 302. However, discarding already successfully received PDCP packets at the UE 110 is inefficient, as it translates to having used unnecessary radio resources at the duplicating nodes, leading to unnecessary network traffic and/or load in the affected cells and additional interference in neighbor cells. Once a duplicated PDCP packet is successfully received at the UE, two different situations concerning this particular duplicated packet can be identified in the duplicating nodes, namely that particular PDCP packet is either in the PDCP buffer awaiting transmission, or it is in the lower layer undergoing MAC-level HARQ transmission/retransmission.

Several solutions have been proposed to overcome such inefficiency. Examples include introduction of a PDCP time-out timer whereby a PDCP packet is ‘flushed’ from the PDCP buffer after a predefined time; and sending a PDCP duplication status report to all the gNBs in the duplication set to indicate the receipt of a duplicated PDCP packet at the UE (see below for details). However, most of the proposed solutions are aimed at discarding the PDCP packet when the packet is still at the PDCP buffer awaiting transmission from the duplicating nodes. Given the low latency constraint of URLLC applications, packets duplicated to boost reliability will most likely be prioritized for transmission from the PDCP buffer. Hence, many of the duplicated packets that have not reached the UE 110 may in fact be undergoing transmission/retransmission at the lower layers, i.e. at the RLC and MAC layers (including potential HARQ retransmissions).

Below, we briefly describe in more detail previously proposed mechanisms to flush duplicated packets at PDCP layer.

In Rel-12 LTE, DC flow control mechanisms are specified for the (secondary node) SN to provide indication to the master node (MN) of the status of the data forwarded from the MN (see X2 interface specification, e.g., in 3GPP TS 36.423).

In Rel-13 LTE-WLAN Aggregation (LWA), a new UE-based feedback framework in the form of LWA status report was defined in order to provide indication to the MN of the packets forwarded through the WLAN link-for the cases when the Xw-interface (a standardized interface between an eNB and a Wi-Fi access point) based feedback is not available. The LWA status report includes the following fields:
First missing sequence number (FMS): The first missing PDCP sequence number (SN) in sequence of received sequence numbers;
Highest received SN on WLAN (HRW): The highest successfully received PDCP sequence number on the WLAN link, or FMS if no PDCP PDUs have been received on the WLAN link; and
Number of missing PDUs (NMP): The number of missing PDCP PDUs with PDCP sequence numbers below HRW starting from and including FMS.

There have been several proposals in 3GPP to allow network signaling over the Xw-interface of the delivered PDCP PDU SNs from the anchor node to the duplicating nodes. This might work fine for the scenarios in which the Xw interface latency is very low such that the network signaling procedure would not imply delays which would make the indication outdated or at least late when arriving at the duplicating nodes. Here, very low is related to the packet delay budget. So for URLLC cases with 1 ms latency target, “very low” is on the order of 0.1 ms, or even lower. For cases where the Xw interface latency is not very low, the UE-based indication proposed herein is more beneficial. For details of allowing network signaling over Xw of the delivered PDCP PDU SNs from the anchor node to the duplicating nodes, please refer to the following.

a) Ericsson, in R3-173958 (“Discard the duplicated transmissions of PDCP PDUs”, 3GPP TSG-RAN WG3 #97bis, Prague, Czech Republic, 9-13 Oct. 2017), proposes two ways of discarding the redundant PDUs. One is to “flush”, i.e., to discard all the PDCP PDUs in queue up to a given PDCP PDU SN. Another is to discard the PDCP PDUs between a start and a stop range, when non-contiguous PDCP PDU ranges are given.

b) Huawei, in R3-173922 (“PDCP duplication for EN-DC”, 3GPP TSG RAN WG3 Meeting #97bis, Prague, Czech, 9-13 Oct. 2017), proposes the following:

i. Proposal 1: In case of PDCP duplication in EN-DC, it is proposed to remove the buffered PDCP PDUs in one node if they have already been successfully delivered to the UE in another node.

ii. Proposal 2: Based on the DDDS (Dynamic Delegation Discovery System) report from the splitting node, the anchor node should be able to remove the buffered PDCP PDUs which have already been transmitted to the UE via the splitting node.

iii. Proposal 3: Based on the DDDS report from the anchor node with indication of delivered PDU SN, the splitting node can remove the corresponding PDCP PDU in the buffer.

To minimize and/or prevent redundant duplicated transmissions with DC, methods to stop transmission of successfully received PDCP packets, which have already been transferred to the lower layers (RLC/MAC/PHY) need to be introduced. These methods are applicable to any node, i.e., PDCP-anchor and duplicating nodes. This disclosure proposes such exemplary methods.

This disclosure introduces an exemplary method in an example to keep track at a gNB of the lower layer packets (e.g., RLC/MAC PDUs) mapped to duplicated PDCP PDUs, to quickly identify and discard those pending RLC/MAC packets, which are associated to PDCP PDUs already successfully received by the UE 110 through any of the legs in the duplication set, this way reducing and/or preventing their unnecessary transmissions.

The exemplary steps can be specifically identified, namely.

1) PDCP packets selected for duplication are flagged at the PDCP anchor node 170-1 to identify them as duplicated packets;

2) For packets flagged according to step 1, a bookkeeping mechanism is introduced at all of the duplicating nodes 170-2, to keep track of the identifiers of the lower layer packets (e.g., RLC/MAC PDUs) which carry the duplicated PDCP packets; and

3) Once a duplicated PDCP PDU pending at a gNB is known to have been already received by the UE, the gNB can discard the PDCP PDU also if the packet has already left the PDCP layer and is pending in the lower layers (e.g., in the MAC pending HARQ retransmission) based on the mapping mechanism introduced in step 2. The duplicating gNB 170-2 can determine that the packet has been sent to the lower layers and is buffered at the lower layers.

Detailed exemplary descriptions of the proposed features (1) and (2) are provided immediately below.

Regarding (1), PDCP PDU packets selected for duplication are flagged at the PDCP-anchor node 170-1 to identify the packets were duplicated, so their lower layer identifiers can be tracked both at the PDCP-anchor node and duplicating nodes.

In order for the PDCP-anchor gNB 170-1 to flag duplicated PDCP PDU packets, this could be achieved in-band (i.e., to be carried as part of the packet itself), e.g., either using one of the existing control information bits in the packet header or adding or appending one additional bit (e.g., or more bits) in the header to indicate the duplication flag.

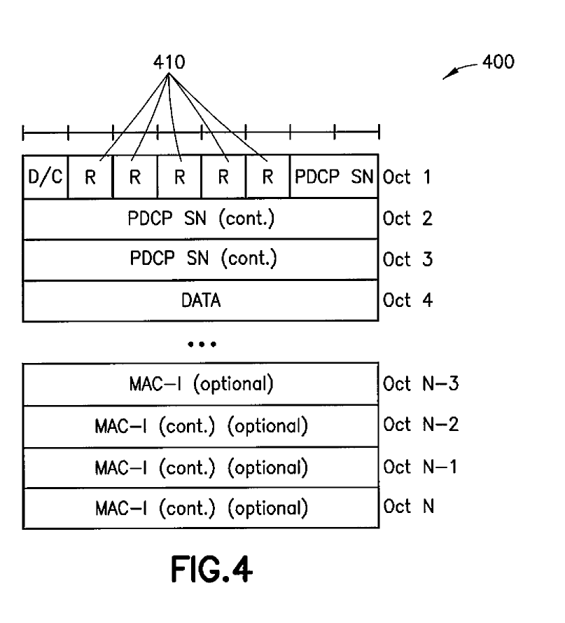

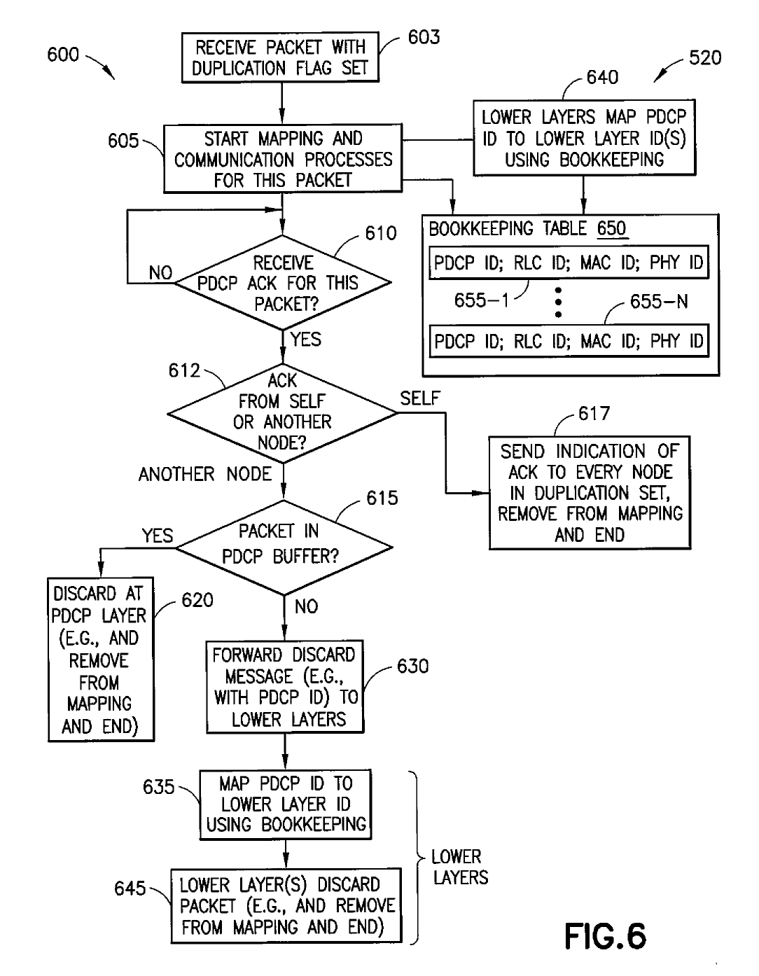

In one exemplary option, the duplication flag (e.g., one bit, where “1” might mean this packet is duplicated) can be inserted as part of the PDCP header using one of the reserved (R) bits. FIG. 4 illustrates an example of a PDCP header 400 with a number of reserved bits 410. This figure is a modified copy of FIG. 6.2.23-1, “PDCP Data PDU format for DRBs with 18 bits PDCP SN (applicable for UM DRBs and AM DRBs)”, from 3GPP TS 38323 V1.0.1 (2017-October). Similarly, the anchor gNB 170-1 could insert a duplication flag using one of the reserved bits in, e.g., RLC/MAC headers—assuming one-to-one mapping between a PDCP PDU and RLC/MAC PDU, e.g., thanks to the limited payload size expected for URLLC traffic. While only the PDCP packets are sent over the Xn interface, when the duplicating node 170-2 receives a PDCP packet (with duplication flag set), the node can set a similar flag when sending the packet to RLC/MAC layers 303/304.

In FIG. 5, this figure illustrates NR DC/MC operation with data duplication in the downlink direction, in accordance with an exemplary embodiment. This figure is similar to FIG. 2, so only part of the figure will be described. The protocol stack 150 in the PDCP anchor node 170-1 is shown comprising the following layers: PDCP layer 302, RLC layer 303, MAC layer 304, and PHY layer 305. The protocol stack 151 in the PDCP duplicating node 170-2 is shown comprising the following layers: PDCP layer 302, RLC layer 303, MAC layer 304, and PHY layer 305. Relative to FIG. 2, some or all of the layers 302-305 could be modified to implement the exemplary embodiments for the protocol stacks 150 and 151.

Step (1) is shown via the block 510, which indicates that duplicated packets are flagged and forwarded, by the anchor node 170-1, to the duplicating node 170-2. To effect this, the anchor node 170-1 adds a duplication flag 540 into the PDCP PDU 312 (in this example) and in this example to create a packet 210′ which then is packaged into the PDCP PDU 312. This creates a modified PDCP PDU 312′, which contains a modified PDCP PDU 312 and the packet 210′. The modified PDCP PDU 312′ is sent via the link 235 to the duplication node 170-2, which might remove the duplication flag 540 from the modified PDCP PDU 312 sometime after reception of the PDCP PDU 312, depending on implementation. In this example, the duplication flag 540 is left in the PDCP PDU 312 to alert the lower layers 303/304 that bookkeeping should be performed, although other techniques to indicate this could be used. The modified PDCP PDU 312′ is also sent via the link 230 toward the PHY layer 305 for transmission over the link 111-1 toward the UE 110.

It should be noted that blocks 510 and 520 (block 520 is described below) indicate the operation of an exemplary method, a result of execution of computer program instructions embodied on a computer readable memory, functions performed by logic implemented in hardware, and/or interconnected means for performing functions in accordance with exemplary embodiments.

Regarding (2), a bookkeeping mechanism may be used to keep track of the lower layer identifiers of the duplicated PDCP packets. Depending on the architecture, the buffering options and the traffic load, it can take some time before a PDCP packet that has left the PDCP buffer is actually transmitted and successfully received by the UE. For instance, the packet may be queued, e.g., at the RLC/MAC buffer of the duplicating node 170-2 awaiting scheduling decisions, or the packet may undergo a physical-level retransmission (e.g., HARQ retransmission).

For the sake of an example, let us suppose that a given duplicated PDCP PDU 312 is successfully received at the UE 110 via the anchor PDCP node 170-1. Once the anchor PDCP node 170-1 receives the related HARQ ACK (indicating successful reception at the UE 110), that information should be conveyed quickly (e.g., immediately) to the other gNB nodes 170-2 in the duplication set 180. Due to the aforementioned flagging mechanism, the pending duplicated PDCP packet (e.g., PDCP PDU 312 at the duplicating node 170-2) can be immediately discarded. This is valid for cases, e.g., where the duplicated PDCP packet is still buffered in the PDCP layer 302, RLC layer 303, or in the MAC layer 304 (e.g., a pending HARQ retransmission).

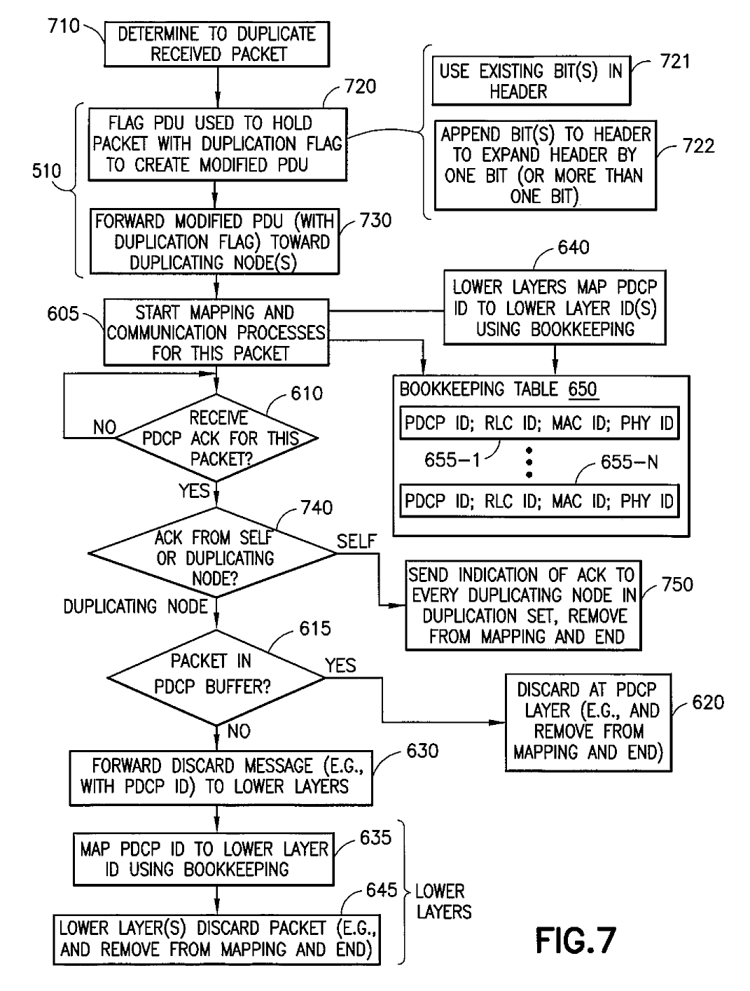

To allow that, an exemplary embodiment proposes that the lower layers maintain a bookkeeping (e.g., a mapping table) of the duplicated PDCP packets by keeping track of the mapping between PDCP ID (e.g., a PDCP PDU SN) and lower layer packet identifiers, as depicted in reference number 520 of FIG. 5. These are also described in FIGS. 6 and 7.

Hence, when a node 170-2 receives an ACK related to PDCP packets undergoing transmission, the node 170-2 can forward a discard message to the lower layers with the relevant PDCP ID (e.g., PDCP PDU SN). The lower layers can then identify the successfully received packet(s) using the proposed mapping between PDCP ID and lower layer IDs, and discard the packet. The duplicated PDCP packet discard message flow is depicted in FIG. 6.

Note that this process of discarding packets in response to an ACK being received may also occur on the PDCP anchor node 170-1. That is, the UE 110 may send an ACK to the PDCP anchor node 170-1 that the UE 110 has received a packet from the PDCP duplicating node 170-2, and the PDCP anchor node 170-1 would then discard the packet if the packet has not yet been sent or has been sent and is buffered, as described in more detail below. It is noted that the ACK for a packet received by the UE from the PDCP duplicating node 170-2 may, depending on implementation, get sent by the UE 110 to the PDCP anchor node 170-1 or by the UE 110 to the PDCP duplicating node 170-2 and from the PDCP duplicating node 170-2 to the PDCP anchor node 170-1.

Referring to FIG. 6, this figure is a flow diagram of a process for flushing PDCP packets to reduce network load in multi-connectivity scenarios. FIG. 6 illustrates the operation of an exemplary method or methods, a result of execution of computer program instructions embodied on a computer readable memory, functions performed by logic implemented in hardware, and/or interconnected means for performing functions in accordance with exemplary embodiments. The duplicating gNB 170-2 causes the blocks in FIG. 6 to be performed, e.g., under control in part of the protocol stack 151.

In block 603, the PDCP duplicating node 170-2 receives a PDCP packet with a duplication flag 540 set. The PDCP duplicating node 170-2 in block 605 starts mapping and communication processes for this packet. For instance, the PDCP duplicating node 170-2, as part of the communication process, can send the packet through the path 245, to be transmitted by the PHY layer 305 at some point.

For the mapping process, the PDCP duplicating node 170-2 can set up a mapping for this packet, e.g., using the PDCP ID, which mapping indicates this is a duplicated packet. This might be performed, in an exemplary embodiment, by use of a bookkeeping table 650, having one or more entries 655, in this example having entries 655-1 through 655-N. Each entry 655 might include one or more a PDCP ID, RLC ID, MAC ID, and/or PHY ID. The PDCP duplicating node 170-2 also in block 640 has the lower layers map the PDCP ID to lower layer ID(s) (such as RLC ID(s), MAC ID(s) and/or PHY ID(s)) using bookkeeping. These IDs can be anything that might be used to uniquely identify a packet, such as a sequence number (SN). The bookkeeping, e.g., via the table 650 or some other data structure, allows a lower layer 303/304/305 to determine which packet should be discarded, e.g., in response to a message from upper layer(s). Note that block 640 can be considered to be a version of block 520 of FIG. 5.

In block 610, it is determined whether a PDCP ACK is received at the PDCP duplicating node 170-2. This may be done by consulting a bookkeeping table 650 in the mapping, such that it is known to which PDCP PDU the physical layer ACK corresponds. If not (block 610=No), the flow proceeds to block 610 again. If the PDCP ACK has been received at the PDCP duplicating node 170-2 (block 610=Yes), in block 612 the PDCP duplicating node 170-2 determines if the ACK for the packet has been received by itself (e.g., from the UE 110 via the protocol stack 151) or from another node 170 in the duplication set 180. The nodes 170 could include the PDCP anchor node 170-1 or another PDCP duplicating node 170-2. If the ACK has been received by itself (block 612=Self), the flow for the PDCP duplicating node 170-2 proceeds to block 617, where the PDCP anchor node 170-1 sends an indication of the ACK to every node 170-1/2 (the PDCP anchor node 170-1 or another PDCP duplicating node 170-2) in the duplication set 180, and removes the packet from the mapping and ends.

If the PDCP duplicating node 170-2 determines the ACK has been received from another node (block 612=Another node), the PDCP duplicating node 170-2 determines if the packet is in the PDCP buffer in block 615. If the packet is in the buffer (block 615=Yes), the packet is discarded at the PDCP layer 302 in block 620. The PDCP duplicating node 170-2 may also remove this packet from the mapping and end the flow.

If the packet is not in the PDCP layer 302 (block 615=No), the flow proceeds to block 630. In block 630, the PDCP duplicating node 170-2 forwards a discard message to lower layers (e.g., the following layers: RLC layer 303, MAC layer 304, and PHY layer 305). Blocks 635 and 645 are performed by the lower layer(s) 303, 304, and/or 305. Block 635 indicates the lower layer(s) map the PDCP ID to corresponding lower layer ID(s) using bookkeeping, such as by using entries 655 in the bookkeeping table 650. Block 645 indicates that one or more of the lower layers 303, 304, and/or 305 will discard (e.g., flush) the packet based on the forwarded discard message. This discarding uses the bookkeeping from block 635 in order to determine the correct packet to discard. The PDCP duplicating node 170-2 might also remove this packet from the mapping (e.g., in an entry 655 in the bookkeeping table 650) and end the flow.

FIG. 7 is a logic flow diagram of part of a process for flushing PDCP packets to reduce network load in multi-connectivity scenarios. FIG. 7 is performed by the anchor node 170-1. This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the protocol stack 150 may include multiples ones of the blocks in FIG. 7, where each included block is an interconnected means for performing the function in the block. The blocks in FIG. 7 are assumed to be performed by the anchor node 170-1, e.g., under control of the protocol stack 150 at least in part.

In block 710, the anchor node 170-1 determines to duplicate a received packet, e.g., an IP packet 310. The anchor node 170-1 in block 720 flags the PDU (e.g., PDCP PDU 312) used to hold duplicated packet with a duplication flag 540 to create a modified PDU (e.g., modified PDCP PDU 312′). As previously described, the duplication flag 540 might be implemented in an exemplary embodiment by using a reserved bit (or bits) 410 in the PDCP Data PDU format of the PDCP header 400 (see block 721) or by appending a bit (or bits) to the header to expand the header by a bit (or bits) (see block 722). The anchor node 170-1 in block 730 forwards the modified PDU (with the duplication flag) toward one or more duplicating nodes 170-2. This occurs via path 235. Note that blocks 720 and 730 may be considered to be a version of block 510 from FIG. 5.

Similar to what occurs on the PDCP duplicating node 170-2 in FIG. 6, the PDCP anchor node 170-1 starts mapping and communication processes for this packet in block 605. Many of the subsequent operations in FIG. 7 are similar to or the same as those performed in FIG. 6. In this case, however, a modified PDCP PDU 312′ is sent via path 230 in the PDCP anchor node 170-1 through the protocol layers 320/303/304/305 for transmission via the PHY layer 305 toward the UE 110 using link 111-1.

Thus, a received packet 210 is sent via two different pathways, one toward the UE (path 230) and one toward one or more duplicating nodes (path 235). It should be noted that the mapping and communication processes starting in block 610, and the operations performed in blocks 720 and 730 would typically be performed in parallel, such that the received packet is sent via the two different pathways in parallel.

For the mapping process, the PDCP anchor node 170-1 can set up a mapping for this packet, e.g., using the PDCP ID, which mapping indicates this is a duplicated packet. As with FIG. 6, this might be performed, in an exemplary embodiment, by use of the bookkeeping table 650, having one or more entries 655, in this example having entries 655-1 through 655-N. Each entry 655 might include one or more a PDCP ID, RLC ID, MAC ID and/or PHY ID. The PDCP anchor node 170-1 also in block 640 has the lower layers map the PDCP ID to lower layer ID(s) (such as RLC ID(s) and/or MAC ID(s)) using bookkeeping. As previously described, the bookkeeping, e.g., via the table 650 or some other data structure, allows a lower layer 303/304/305 to determine which packet should be discarded, e.g., in response to a message from upper layer(s).

In block 610, it is determined whether a PDCP ACK is received at the PDCP anchor node 170-1. This may done by consulting a bookkeeping table in the mapping, such that it is known to which PDCP PDU the physical layer ACK corresponds. If not (block 610=No), the flow proceeds to block 610 again. If the PDCP ACK has been received at the PDCP anchor node 170-1 (block 610=Yes), the PDCP anchor node 170-1 determines if the ACK is from itself (e.g., from the UE 110 and via the protocol stack 150) or from duplicating node 170-2 in a duplication set 180. As previously described, the ACK for a packet received by the UE from the PDCP duplicating node 170-2 may, depending on implementation, get sent by the UE 110 to the PDCP anchor node 170-1 (and therefore up the protocol stack 150 to an appropriate layer) or by the UE 110 to the PDCP duplicating node 170-2 and from the PDCP duplicating node 170-2 to the PDCP anchor node 170-1. If the ACK is from itself (block 740=self), in block 750, the PDCP anchor node 170-1 sends an indication of the ACK to every duplicating node 170-2 in duplication set 180, and the packet is removed from the mapping (e.g., the entry. 655 that corresponds to this packet in the bookkeeping table 650 is deleted or otherwise removed) and the flow ends.

If the ACK is from a duplicating node (block 740=duplicating node), the flow proceeds to block 615, where the PDCP anchor node 170-1 determines if the packet is in the PDCP buffer in block 615. If the packet is in the buffer (block 615=Yes), the packet is discarded at the PDCP layer 302 in block 620. The PDCP anchor node 170-1 may also remove this packet from the mapping and end the flow.

If the packet is not in the PDCP layer 302 (block 615=No), the flow proceeds to block 630. In block 630, the PDCP anchor node 170-1 forwards a discard message to lower layers (e.g., the following layers: RLC layer 303, MAC layer 304, and PHY layer 305). Blocks 635 and 645 are performed by the lower layer(s) 303, 304, and/or 305. Block 635 indicates the lower layer(s) map the PDCP ID to corresponding lower layer ID(s) using bookkeeping, such as by using entries 655 in the bookkeeping table 650. Block 645 indicates that one or more of the lower layers 303, 304, and/or 305 will discard (e.g., flush) the packet based on the forwarded discard message. This discarding uses the bookkeeping from block 635 in order to determine the correct packet to discard. The PDCP anchor node 170-1 might also remove this packet from the mapping (e.g., in an entry 655 in the bookkeeping table 650) and end the flow.

Without in any way limiting the scope, interpretation, or application of the claims appearing below, exemplary benefits and technical effects of these embodiment include one or more of the following:
Reduce unnecessary transmission from the multiple gNBs;
Freeing network resources which then can be allocated elsewhere;
Reduce network interference by minimizing unnecessary transmission;
Consequently, improving the reliability of URLLC transmissions; and/or
Improving the overall network energy efficiency and spectral efficiency.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

3GPP third generation partnership project

5G fifth generation

ACK acknowledgment

CA carrier aggregation

DC dual connectivity

DL downlink

E-UTRAN evolved universal terrestrial radio access network

gNB or gNode B Node B (a base station) for NR/5G

EN-DC E-Utran-NR DC

H header

HARQ hybrid automatic repeat request

HRLC high reliability low latency

ID identification

I/F interface

IP Internet protocol

LTE long term evolution

LWA LTE-WLAN aggregation

MAC medium access control

MC multi-connectivity

MgNB master gNode B

MN master node

MME mobility management entity

ms millisecond

NCE network control element

NE-DC NR-E-Utran DC

NR new radio

N/W network

PDCP packet data convergence protocol

PDU packet data unit

PHY physical (layer)

RB resource block

Rel release

RLC radio link controller

RRH remote radio head

Rx receiver

SDAP service data adaptation protocol

SDU service data unit

SgNB secondary gNode B

SGW serving gateway

SN sequence number

TB transport block

TS technical specification

Tx transmitter

UE user equipment (e.g., a wireless, typically mobile device)

UL uplink

UM unacknowledged mode

URLLC ultra reliable low latency communication

WLAN wireless local area network

X2 X2 interface between two eNBs

Xn Xn interface between two gNBs

Xw Interface between LTE eNB and a Wi-Fi access point

What is claimed is:

1. A method, comprising:
receiving a packet at an anchor node in a communications network;
duplicating, by the anchor node, the packet to form two copies of the packet;
flagging, by the anchor node, each of two data units, each comprising one of the two copies, with a duplication flag indicating the corresponding data unit comprises a copy of the packet;
sending, by the anchor node, one of the two data units, with one of the copies, through a plurality of protocol layers toward transmission via an air interface toward a user equipment; and
sending, by the anchor node, another of the two data units, with the other copy, over a network interface and toward one or more duplicating nodes.

2. The method of claim 1, wherein:
the data unit comprises a packet data convergence protocol (PDCP) packet data unit (PDU); and
the duplication flag is one or more bits in a header of the PDCP PDU.

3. The method of claim 2, wherein the one or more bits is one of existing control information bits in the header that were previously reserved prior to being used for the duplication flag.

4. The method of claim 2, wherein the one or more bits are appended to existing control information bits in the header to create a larger header than before the one or more bits was or were appended.

5. The method of claim 1, further comprising, in response to receiving an acknowledgement from the user equipment for this packet, the anchor node sending an indication of reception of the acknowledgement toward every duplicating node in a duplication set of nodes.

6. The method of claim 1, further comprising, in response to receiving an acknowledgement from at least one of the one or more duplicating nodes that the packet has been received by the user equipment, the anchor node discarding, in the first protocol layer or in a layer lower than the first protocol layer, the packet.

7. A method, comprising:
receiving a data unit at a duplicating node in a communications network, wherein the duplicating node receives in the data unit a copy of a packet that is also sent via one or more nodes in a duplication set of nodes toward a user equipment, the data unit comprising a duplication flag indicating the corresponding data unit comprises a copy of the packet;
forwarding the data unit with the packet to a first protocol layer of a plurality of layers toward transmission via an air interface toward the user equipment; and
discarding, in the first protocol layer or in a layer lower than the first protocol layer, the packet in response to receiving an acknowledgement at the duplicating node that a copy of the packet was successfully received by the user equipment.

8. The method of claim 7, wherein:
the method further comprises forwarding, in response to receiving the acknowledgement at the duplicating node that the data was successfully received by the user equipment, a message toward lower layers that are lower than the first layer, the message indicating any of the lower layers should discard the packet; and
the discarding of the packet and its corresponding data unit is performed by one of the lower layers in response to the forwarded message.

9. The method of claim 8, wherein:
the method further comprises performing bookkeeping of the packet in order to keep track of mapping between a unique identification of the packet with lower layer packet identifiers for data units at those lower layers for the packet; and
the discarding of the packet and its corresponding data unit is performed at the first layer or any of the lower layers using the bookkeeping to determine which data unit corresponds to the unique identification.

10. The method of claim 7, further comprising:
determining, in response to receiving the acknowledgement at the duplicating node that the copy of the packet was successfully received by the user equipment, the packet has been transmitted by the air interface and is currently buffered; and
performing, in response to the determining the packet has been transmitted by the air interface and is currently buffered, the forwarding the message toward lower layers that are lower than the first layer, the message indicating any of the lower layers should discard the packet.

11. An apparatus, comprising:
one or more processors; and
one or more memories including computer program code,
the one or more memories and the computer program code configured, with the one or more processors, to cause the apparatus to perform at least the following:
receiving a packet at an anchor node in a communications network;
duplicating, by the anchor node, the packet to form two copies of the packet;
flagging, by the anchor node, each of two data units, each comprising one of the two copies, with a duplication flag indicating the corresponding data unit comprises a copy of the packet;
sending, by the anchor node, one of the two data units, with one of the copies, through a plurality of protocol layers toward transmission via an air interface toward a user equipment; and
sending, by the anchor node, another of the two data units, with the other copy, over a network interface and toward one or more duplicating nodes.

12. The apparatus of claim 11, wherein:
the data unit comprises a packet data convergence protocol (PDCP) packet data unit (PDU); and
the duplication flag is one or more bits in a header of the PDCP PDU.

13. The apparatus of claim 12, wherein the one or more bits is one of existing control information bits in the header that were previously reserved prior to being used for the duplication flag.

14. The apparatus of claim 12, wherein the one or more bits are appended to existing control information bits in the header to create a larger header than before the one or more bits was or were appended.

15. The apparatus of claim 11, wherein the one or more memories and the computer program code are further configured, with the one or more processors, to cause the apparatus to perform at least the following: in response to receiving an acknowledgement from the user equipment for this packet, the anchor node sending an indication of reception of the acknowledgement toward every duplicating node in a duplication set of nodes.

16. The apparatus of claim 11, wherein the one or more memories and the computer program code are further configured, with the one or more processors, to cause the apparatus to perform at least the following: in response to receiving an acknowledgement from at least one of the one or more duplicating nodes that the packet has been received by the user equipment, the anchor node discarding, in the first protocol layer or in a layer lower than the first protocol layer, the packet.

17. An apparatus, comprising:
one or more processors; and one or more memories including computer program code,
the one or more memories and the computer program code configured, with the one or more processors, to cause the apparatus to perform at least the following:
receiving a data unit at a duplicating node in a communications network, wherein the duplicating node receives in the data unit a copy of a packet that is also sent via one or more nodes in a duplication set of nodes toward a user equipment, the data unit comprising a duplication flag indicating the corresponding data unit comprises a copy of the packet;
forwarding the data unit with the packet to a first protocol layer of a plurality of layers toward transmission via an air interface toward the user equipment; and
discarding, in the first protocol layer or in a layer lower than the first protocol layer, the packet in response to receiving an acknowledgement at the duplicating node that a copy of the packet was successfully received by the user equipment.

18. The apparatus of claim 17, wherein:
wherein the one or more memories and the computer program code are further configured, with the one or more processors, to cause the apparatus to perform at least the following: forwarding, in response to receiving the acknowledgement at the duplicating node that the data was successfully received by the user equipment, a message toward lower layers that are lower than the first layer, the message indicating any of the lower layers should discard the packet; and
the discarding of the packet and its corresponding data unit is performed by one of the lower layers in response to the forwarded message.

19. The apparatus of claim 18, wherein:
wherein the one or more memories and the computer program code are further configured, with the one or more processors, to cause the apparatus to perform at least the following: performing bookkeeping of the packet in order to keep track of mapping between a unique identification of the packet with lower layer packet identifiers for data units at those lower layers for the packet; and
the discarding of the packet and its corresponding data unit is performed at the first layer or any of the lower layers using the bookkeeping to determine which data unit corresponds to the unique identification.

20. The apparatus of claim 18, wherein the one or more memories and the computer program code are further configured, with the one or more processors, to cause the apparatus to perform at least the following:
determining, in response to receiving the acknowledgement at the duplicating node that the copy of the packet was successfully received by the user equipment, the packet has been transmitted by the air interface and is currently buffered; and
performing, in response to the determining the packet has been transmitted by the air interface and is currently buffered, the forwarding the message toward lower layers that are lower than the first layer, the message indicating any of the lower layers should discard the packet.
